(19) United States
(12) Patent Application Publication
(10) Pub. No.: US 2022/0156600 A1
(43) Pub. Date: May 19, 2022

(54) USING GRAPH PATTERNS TO AUGMENT INTEGRATION OF MODELS INTO A SEMANTIC FRAMEWORK

(71) Applicant: General Electric Company, Schenectady, NY (US)

(72) Inventors: Andrew Walter CRAPO, Niskayuna, NY (US); Nurali VIRANI, Niskayuna, NY (US)

(73) Assignee: General Electric Company, Schenectady, NY (US)

(21) Appl. No.: 17/439,721

(22) PCT Filed: Mar. 16, 2020
(86) PCT No.: PCT/US2020/023031

§ 371 Date: Sep. 15, 2021

Related U.S. Application Data
(60) Provisional application No. 62/818,873, filed on Mar. 15, 2019.

(51) Int. Cl. G06N 5/02; G06N 5/04

(52) U.S. Cl. CPC G06N 5/022; G06N 5/04

(57) ABSTRACT

Provided is a computer system including at least one processor for modeling operations related to capturing domain knowledge. The operations include creating, via the processor, a graph model of inputs to an equation relevant to the domain knowledge. The graph model relates at least one of the inputs to another one of the inputs; and wherein the graph model relates the inputs to an output. The operations also include deriving augmented-type information from the graph model and adding, via the processor, the derived augmented-type information to the equation, the adding facilitating use of the equation by artificial intelligence.

### I. TECHNICAL FIELD

The technical field relates generally to capturing domain knowledge. More particularly, the technical field relates to capturing domain knowledge for use in artificial intelligence.

### II. BACKGROUND

Artificial intelligence (AI) is widely accepted as the most revolutionary achievement in computer science and is used in every technological field to aid the human experience. AI touches every aspect of life and business: from healthcare to agriculture and farming, to autonomous vehicles and flying, manufacturing, to retail fashion and shopping, and the list goes on.

Even more fascinating, AI is now performing tasks that simulate human intelligence, such as thinking autonomously and reasoning at the level of humans. For example, AI is key in the design, development, and testing of new computer programs and is used in inventing technology. To perform these higher-level intelligence tasks, humans (e.g., subject matter experts) must be able to transfer in-depth knowledge and expertise into AI computers in meaningful ways.

For example, a great deal of a subject matter expert's (SME's) scientific knowledge can be found in written documents, and perhaps most explicitly in computer program code encapsulating scientific calculations. To some extent, all of these repositories of scientific knowledge have, as their target audience, other SMEs or humans with some level of skill in a particular technical domain.

For documents, skill is required to correctly interpret the meaning of the text. For computer programs, the skill is in providing correct inputs inputs that are consistent in ways that may be left implicit to some degree, or that conform with documentation that must be read by the user. Unfortunately, implicit computer program inputs, that may be sufficient for human interpretation, represent ambiguities for AI computer and cannot be interpreted.

This becomes a critical problem when computational models are to be integrated into the semantic framework of an AI that is expected to make use of the models, so that the outputs of one model are the inputs to another model, etc. In other words, all of the implicit knowledge that an SME uses to properly invoke the computational models must now be explicitly captured in the knowledge base of an AI computer.

The need for explicit capture creates a significant deficiency in traditional AI computers. The deficiency is that traditional AI computers do not include an ability or mechanisms to explicitly capture the implicit knowledge of an SME in a semantic framework.

### III. SUMMARY OF THE EMBODIMENTS

Given the aforementioned deficiencies, a need exists for systems and methods that provide an ability to explicitly capture the implicit domain knowledge of an SME in a semantic framework. What is also needed are methods and systems that enable an AI based computer to apply the knowledge represented in an equation in a manner similar to that of a human of ordinary skill in the art.

More specifically, methods and systems are needed that use graph patterns to capture the domain knowledge of the relationships between all inputs of a mathematical equation to each other, and the relationship of all of the inputs to an output of the equation.

Under certain circumstances, embodiments of the present invention include a computer system including at least one processor for modeling operations related to capturing domain knowledge. The operations comprise creating, via the processor, a graph model of inputs to an equation relevant to the domain knowledge. The graph model relates at least one of the inputs to another one of the inputs, wherein the model relates the inputs to an output. The operations also include deriving augmented-type information from the graphical model, and adding the derived augmented-type information to the equation, the adding facilitating use of the equation by artificial intelligence.

Pursuant to some embodiments, knowledge that is often implicit (and only provided by human experts, for example) is made explicit in the captured knowledge and made available for machine inference.

Embodiments permit using graph patterns to capture the domain knowledge of the relationships between the inputs and outputs, that is the relationship of all the inputs to each other, and the output to all of the inputs—for any type of mathematical and/or scientific equation.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### IV. DESCRIPTION OF THE DRAWINGS

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

FIG. 1 is an illustration of the conventional Mach number equation and example aircraft achieving Mach number flight.

FIG. 2 is an illustration of a conventional speed of sound calculation and illustration, provided courtesy of NASA Glenn Research Center.

FIG. 3 is an illustration of a conventional human user applet interface for Mach calculations (NASA Glenn Research Center).

FIG. 4 is an exemplary illustration of a graph model of a knowledge domain class hierarchy of a first type of relationships in accordance with embodiments of the invention.

FIG. 5 is an exemplary illustration of a graph model of a knowledge domain class hierarchy of a second type of relationships in accordance with the embodiments.

FIG. 6 is an exemplary illustration of graph model of a portion of range and domain for a physical object in accordance with the embodiments.

FIG. 7 is a flowchart of an exemplary method of practicing in embodiment of the present invention.

FIG. 8 is a block diagram illustration of a non-generic computer system on which embodiments of the invention may be implemented.

### V. DETAILED DESCRIPTION

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components.

In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

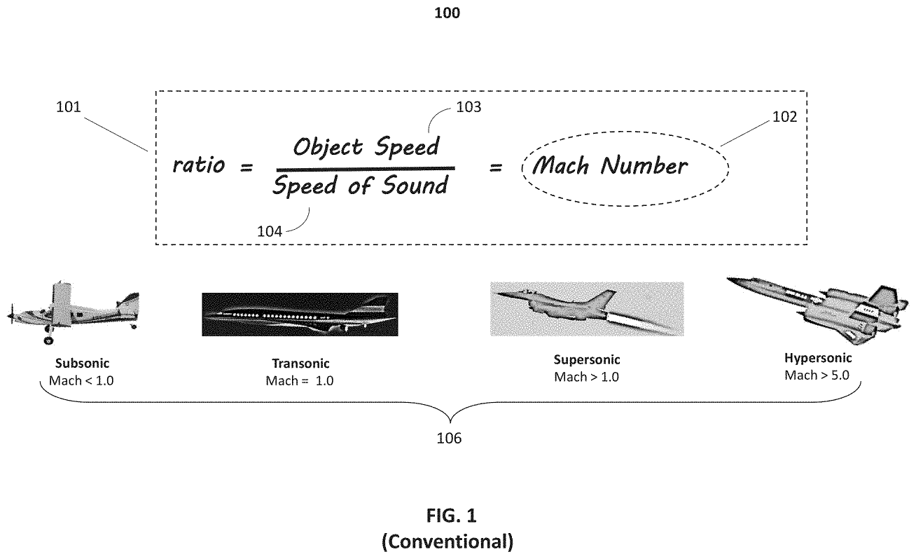

In FIG. 1, a conventional example of a simple knowledge domain is provided. The domain relates to the speed of sound, and for example, will be referred to herein as Mach domain 100. The Mach domain 100 includes an equation 100 for calculating Mach number 102: the ratio of an object's speed 103 in-flight to the speed of sound 104.

Various aircraft (i.e., an object) 106 in FIG. 1, are depicted at various speeds relative to the Mach number 102. The conventional illustration of FIG. 1 represents challenges to AI computers relative to knowledge domains. These problems are solved by the embodiments and are addressed in detail below.

Implicit in the illustration of FIG. 1 (i.e., Example #1) are the following questions: Is this the speed of the sound 104 the speed of sound in water? Is the speed of sound 104 the speed of sound through air at the North Pole with the object 106 flying at the equator? Although the answer to these questions is no, this answer is not explicit in the equation 101.

That is, the answer to these questions depends on the knowledge in the SME's head to know that the object speed 103 must be divided by the speed of sound 104 at the location where the object 106 is moving through the air. Thus, if the object 106 is moving through the air at an altitude of 32,000 feet, then that is where the speed of sound 104 is measured: at 32,000 feet. An SME would understand this assumption when using the equation 101 in FIG. 1. An AI based computer would not be able to make this assumption and effectively use the simple equation 101 in FIG. 1.

In a more complex case (Example #2), consider that the maximum total thrust for an aircraft is as follows: [the number of aircraft engines]×[total net thrust/engine]. How would an AI computer use this equation? The relationship is: Total thrust of an aircraft=[the number of engines of the aircraft]×[the net thrust of an engine of the aircraft]. The assumption is that all of the engines on the aircraft have the same net thrust.

The challenge, when trying to solve an equation using AI, is to explicitly capture the relationships between all of the inputs to the equation (to each other), and the relationship of the inputs to the equation to the output, in domain terms. These relationships are captured by relating them all to the same object. In this more complex case (example #2), the object was the aircraft.

In FIG. 1. (Example #1), the object was the atmosphere. Note that this object is not referring to the object 106. That is, an assumption was added in the example #1 that the speed of sound 104 was the speed of sound through a gas. The addition of this assumption means the equation 101 of FIG. 1 is only valid if the medium is a gas, such as the atmosphere.

Thus, the speed of sound 104 (the denominator) in the equation 101 of FIG. 1 is the speed of sound in the air through which the object 106 is passing. Additionally, the fact that the speeds in the numerator and the denominator must also be in the same units of measure is not explicitly specified in the equation 100, nor is it explicitly stated in the text. This implicit assumption would also represent another ambiguity for an AI computer.

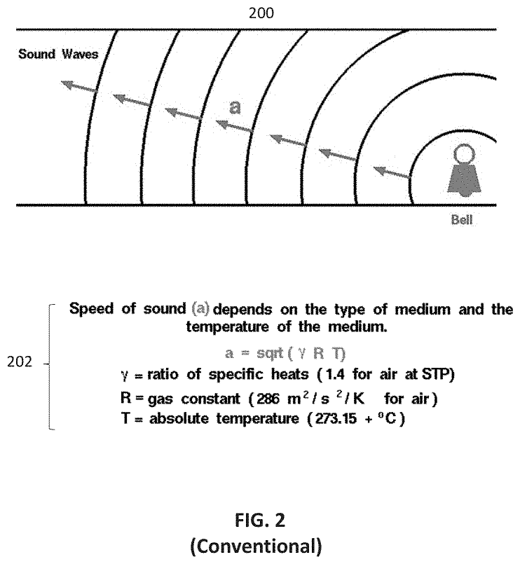

In conventional FIG. 2, the equation for the speed of sound is provided (NASA Glenn Research Center, https://www.qrc.nasa.gov/www/k-12/airplane/images/mach.gif) in a conventional illustration 200 of FIG. 2. More specifically, in the illustration 200, the ratio of specific heats, γ in equation 202, may also be computed. If the speed of the object is large, then the ratio of specific heats is given by:

gam=1+(gamma−1)/(1+(gamma−1)*[(theta/T)\hat{ }*e\hat{ }(theta/T)/(e\hat{ }(theta/T)−1)\hat{ }1)\hat{ }2]) Equation 204:

where
gamma (γ) the ratio of specific heats for a calorically perfect gas, 1.4 for air, theta is a thermal constant, 5,500 degrees Rankine or 3056 degrees Kelvin T is the static temperature.

However, static temperature can be computed from altitude for a “standard Earth day” as follows. If the altitude (h) is less than 36,152 feet (troposphere), then the temperature in degrees F. is given by:

T=59−0.00356 h

If the altitude h is between 36,152 and 82,345 feet, the temperature is:

T=−70

If the altitude h is greater than 82,345 feet, then the temperature is:

T=−205.05+0.00164 h

To properly use these equations, an AI computer must know how the inputs and outputs of each equation are related in domain terms, and must have explicit knowledge of the units of inputs and outputs of each equation and ensure that they are aligned when using multiple equations.

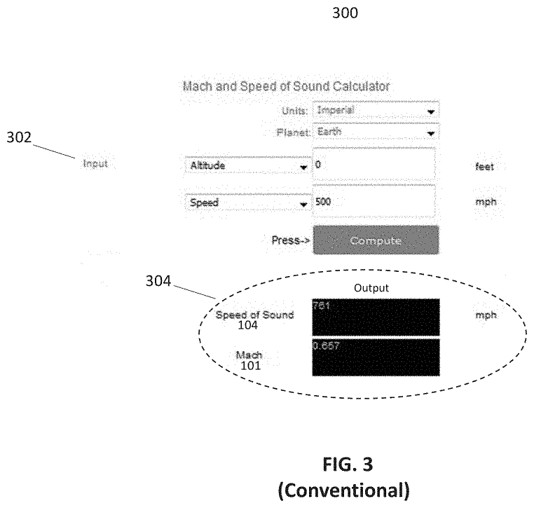

FIG. 3 is an illustration of a conventional user interface 300. This implementation facilitates this task for a human user on the NASA Glenn Research Center by wrapping the computation models in a Java applet. The applet permits a user to make numerical inputs 302 numbers and those equations can be used to compute values

This approach requires the user choose the units. The required units implied by this choice are shown in the applet interface 300, as illustrated in FIG. 3. The Java applet 300 code accomplishes the task of linking the various computational models together in a consistent manner. Appropriate assumptions are baked into the implementation.

FIG. 3 is an illustration of a conventional human user applet interface 300 for Mach calculations (NASA Glenn Research Center, Earth Atmosphere Model, https://www.grc.nasa.gov.www/k-12/airplane/atmos.html). The applet interface 300 permits a user to provide numerical inputs 302 to the applet 300. By way of example, the applet 300 can be used to compute output values 304 such as Mach number 102, calculated by equation 101 and/or speed of sound 104, calculated by equation 202.

In the illustrious example of FIG. 3, all of the domain knowledge is captured in the user interface of the applet 300. The applet 300 provides a precise and efficient mechanism for a user to enter the numerical inputs values 302 and compute numerical output values 304, such as speed of sound 104 and Mach number 102. However, the applet 300 is not suitable for enabling an AI computer to expressly interpret and sufficiently analyze the units of measure of the inputs 302 and the outputs 304 to apply the equations 101 and 202 of FIGS. 1 and 2, respectively. At best, these types of applets merely make the input of data values a more consistent process for a human user.

In the exemplary embodiments, one approach for capturing and communicating knowledge of a domain includes understanding relationships between values of various inputs to equations, representing the domain, to each of the other inputs, and understanding the relationships of those values to the outputs of those equations. Computational modeling is one approach that can define these relationships.

There are multiple formal modeling methodologies that one might use to capture and communicate knowledge of a domain. By way of example only and not limitation, predicate logic is one such methodology, that is also a very powerful formalism, that is often used. If predicate logic is restricted to predicates of arity 2 or less, it corresponds exactly with the graph methods used by the Web Ontology Language (OWL). This is the case because a predicate of arity 2 is an edge in a directed graph. When using graph representations, predicates of arity greater than 2 must be represented by creating additional, mediating concepts that map the arguments of the higher-arity predicate together.

While predicate logic is one approach, other alternatives within the spirit and scope of the embodiments include, but are not limited to, conceptual graphs (CG), ISO standard Common Logic (CL), and Knowledge Interchange Format (KIF).

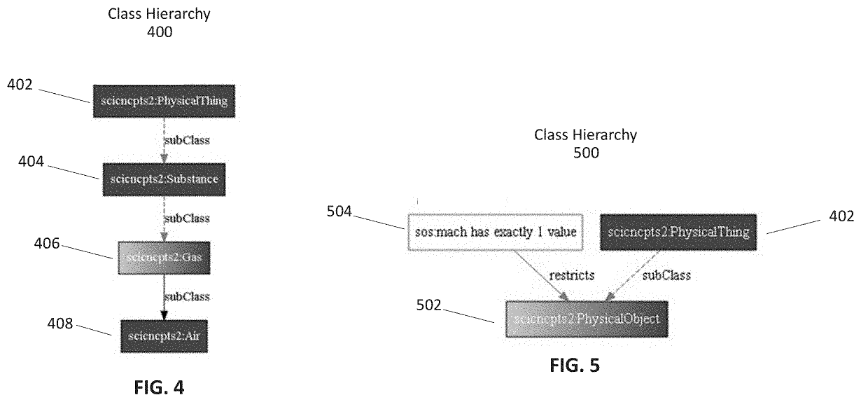

For the example of FIGS. 1-3 above, the Mach number 100 domain can be represented with graph models, such as the graph models illustrated in FIGS. 4-6. Specifically, the exemplary graph model illustrated in FIGS. 4-6 captures explicitly several important relationships within the Mach number domain FIGS. 4-6 also provide exemplary illustrations of how an ontology can be used to depict graphical relationships.

FIG. 4 is an exemplary graph model of a simple class hierarchy 400 of Gas 406. The class hierarchy 400 is used as a classifier to accumulate properties of a PhysicalThing 402. In FIG. 4, the class hierarchy 400 includes the PhysicalThing 402, with a substance 404 modeled as a subclass. Gas 406 is modeled as a subclass of the substance 404, and Air 408 is modeled as a subclass of the Gas 406.

FIG. 5 is an exemplary graph model of another simple class hierarchy 500 of a PhysicalObject 502. The class hierarchy 500 illustrates there is a PhysicalObject 502 as a subclass of the PhysicalThing 402, depicted in FIG. 4. In simple terms, it is the Mach number 102 of a particular PhysicalObject 502 since it can be assumed that only a physical object can have a Mach number (i.e., that is a subclass of the PhysicalThing 402) and move through the Air 408. In FIG. 5, the PhysicalObject 502 is restricted to a single normalized unitless Mach value 504. (Note that if a temporal model was being captured, the Mach number 102 would be a single value an any given instant in time.)

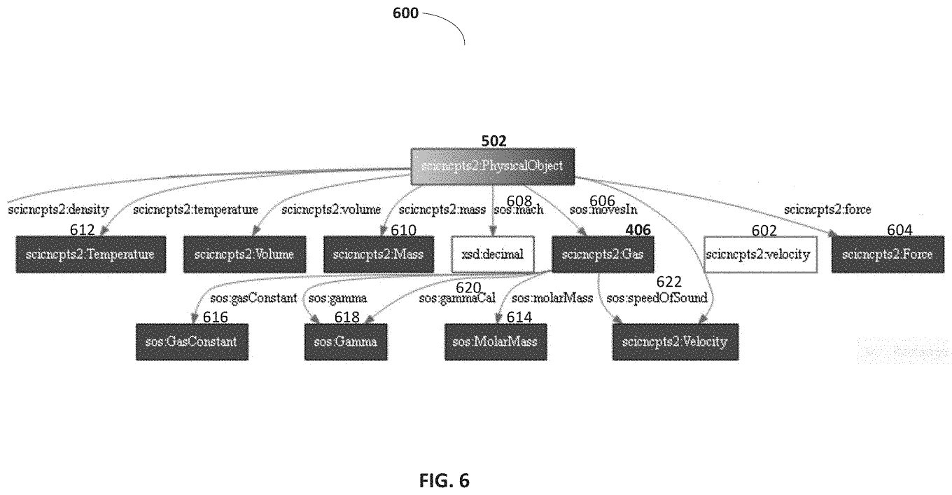

FIG. 6 is an exemplary graph model 600 of relevant subclasses of a portion of the Mach domain 100 and a range graph for the PhysicalObject 502. In particular, the graph model 600 captures explicitly several important relationships relevant to the PhysicalObject 502 and the Gas 406.

For example, the Gas 406 has a MolarMass 614. This value comes into play because one can compute the gasConstant 616 from the universal gas constant and the molecular weight, but the molarMass 614 of that gas that is being computed must be known. By way of example only, and not limitation, the PhysicalObject 502 and the Gas 406 include the subclasses:

Physical Object (502) is in the domain of a number of important properties, including:
velocity 602
force 604 (important for thrust, flight models)
movesIn 606, with range Gas
Mach 608, range decimal
mass 610 (important for thrust, flight models)
temperature 612, inherited from PhysicalThing; Gas also inherits

Gas (406) includes several important properties relevant to gases. By way of example, several properties include:
molarMass 614, used to compute the gasConstant (not shown in above equations, for simplicity)
gasConstant 616, which shows up in the equations above
gamma 618, the calorically perfect gas ratio of specific heats
gammaCal 620, the calorically imperfect gas ratio of specific heats
speedOfSound 622, an important property in the Mach equation above

Graphing the domain model, is achieved in the example of FIGS. 4-6, captures explicitly relationships between the various classes whose property values are inputs and outputs of the equations (e.g., 101 and 202) above. The question is how to best associate this domain information with the computational models represented by these equations.

Most programming languages have some concept of built-in types, e.g., integer, float, string, Boolean, etc. These types are used to specify the type of a variable, the signature of a method call, the type of value or values returned. In an object-oriented language, classes may be defined that align with the classes in the domain model and these classes may then be used as types.

However, there are important differences between the expressivity of most object-oriented languages and the expressivity of a graph-based ontology language. Not least among these is that in most object-oriented languages, properties are represented as fields in a class and have no independent existence. By contrast, properties in graph ontology languages are first-class citizens and can have restrictions on value type, cardinality, etc., based on class of the thing having the property.

This means that more than one class can be in the domain of the same property, and that a property may have restrictions on cardinality, type of value, etc., which are different for different classes but is still identifiably the same property. So even in the case of object-oriented languages, the useful parts of the code may be methods whose types are the built-in or primitive types. Such is the case, for example, in Java applets examples, such as the applet 300 of FIG. 3. The only non-built-in classes used, besides the applet itself, are user-interface classes.

When integrating computational models whose inputs and outputs are typed according to the built-in data types of the language into a semantic framework, both the built-in data type and the semantic domain type are important. However, these two types are insufficient.

Consider some examples using the exemplary equations 101 and 102 above. By way of example, the equations 101 and 202 will be illustrated in the Semantic Application Design Language (SADL) as equations 1-8 below. Other languages, however, could be used. The information content: (1) the primitive data type of the inputs and outputs, (2) the domain concept of which the input or output is a value, and (3) how the inputs and outputs are related in domain terms, is the essential point.

Stated another way, the following is a declaration of the signatures for equations 1-4, speed of sound, gamma of a calorically imperfect gas, temperature of the atmosphere as a function of altitude, and Mach number for a flying object, in terms of the language built-in types of inputs and returned values.

What is determined by this equation (i.e., the equations 1-4), is the speed of sound of the (same) gas, in either meters/sec or ft/sec. The significance of discussing equations 1-4 is to emphasize that the equations 1-4 do not include any augmented-types information. Without augmented-type information, an AI computer would not be able to use the equations 101 and 202, depicted in FIGS. 1 and 2, and capture the knowledge of the Mach domain 100. The inputs (TGRQ, and us) are defined as:
(T) is the temperature of a gas, either in Kelvin or Rankine
(G) is gamma of “the” gas. They use indefinite articles the same way they are used in the English language
(R) is the gas constant of “the” gas. And it has to be “g/mole”, if it is in the metric system (which coincides with Kelvin), or “lbm/lbmole if in the Imperial system
(Q) is theta, which is a constant expressed either in Kelvin or Rankine. There are two instances of this unit theta: one for the metric system or for the Imperial system. The correct system must be used with the correct units
(us) is a unit system, either metric or imperial. If the system is metric, the first set of units (imperial) is used in all of the augmented types. If the Imperial system applies, the second set of units (imperial) is used
1. External CAL_SOS(double T, double G, double R, double Q) returns double.
2. External CAL_GAM(double T, double G, double Q) returns. double
3. External tempFromAltitude (double alt) returns double.
4. External computeMach(double alt, double R, double C, double Q, double vel) returns double.

As stated above, the equations 1-4 do not include any augmented-types information and as a result, the AI computer (illustrated below in FIG. 8) would be unable to choose the appropriate inputs needed to know what the output of the equations mean in domain terms. To accomplish this, the information from the graph models of FIGS. 4-6 can be used to capture explicitly how the inputs and outputs of the computational model relate to each other in the domain model. The graph models of FIGS. 4-6 illustrate these relationships. Graph patterns can be associated with a computational model as a means of making these relationships explicit. For any single computational model, the extent of the graph pattern needed is the domain subgraph that relates all the inputs to each other, and all the inputs to the outputs.

Using the example equations from FIG. 2, the domain model graph patterns necessary to capture the explicit context of the equation are added, depicted in the graph model 600 of FIG. 6. Additionally, the units of measure supported by the graph model 600, are also provided. More specifically, equations 5-8 include augmented-types information (i.e., domain model graph patterns) that enable an AI computer to expressly capture the appropriate use of the equations FIG. 2.

A combination of FIG. 6, which defines the ontology graphically, and FIG. 4-5, provide the augmented-type information to enable the AI computer to disambiguate the meaning of these equations (5-8). Equations 5-8 below, includes the augmented-types information (i.e., the domain model graph patterns) necessary to capture the explicit context of the equation, along with the units supported by the model.
5. External CAL_SOS(double T (temperature of a Gas {Kelvin, Rankine}),
   double G (gamma of the Gas),
   double R (gasConstant of the Gas {“g/mole”, “lbm/lbfole”}),
   double Q (a Theta {Kelvin, Rankine}),
   string us (a Unitsystem {Metric, Imperial}))
   return double (speedOfSound of the Gas {“m/sec”, “ft/set”}).
6. External CAL_GAM(double T (temperature of a Gas {Kelvin, Rankine}),
   double G (gamma of the Gas),
   double Q (a Theta {Kelvin, Rankine}),
   string us (a UnitSystem {Metric, Imperial}))
   returns double (gammaCal of the Gas).
7. External tempFromAltitude (double alt (altitude of some Air {ft}))
   returns double (temperature of the Air {Rankine}).
8. Eternal computeMach(double alt (altitude of a PhysicalObject and the PhysicalObject movesIn some Air {ft, m}),
   double R (gasConstant of the Air {“lbm/lbmole”, “g/mole”}),
   double G (gamma of the Air),
   double Q (a Theta {Kelvin, Rankine}),
   double vel (velocity of the PhysicalObject {“mph”, “km/hr”}),
   string us (a UnitSystem {Metric, Imperial}))
   returns double (mach of the PhysicalObject).

In Equation 5, the graph pattern need only relate properties whose values are being input and output to a particular instance of the class Gas 406. In this syntax, the use of “a Gas” in the first argument and “the Gas in the subsequent arguments and in the return type indicates explicitly that all refer to the same Gas. Thus, the use in this structured-English language is consistent with meaning in standard English usage. The same is true in Equation 6. In Equation 7, the computational model being described is actually specific to Air 408, not just any subclass of Gas 406. This is important to capture.

In Equation 8, which is illustrative of a more complex equation that includes properties of more than one concept, the inputs and outputs are related via a graph pattern going up to the node representing the instance of a PhysicalObject, defined as “a” PhysicalObject in the first argument and “the” PhysicalObject (502) in subsequent arguments and in the return value. Note that the first reference to “Air” is “some Air”. This is an allowed alternative to “an Air” as it is more natural-sounding for a substance. Note also that an equation might have made reference to more than one PhysicalObject, in which case the identity of each different object must be made explicitly clear.

This can be accomplished in the SADL language by using “a PhysicalObject”, “the Physical Object”, etc., for the first, and “a second PhysicalObject”, “the second PhysicalObject”, etc., for the second. This extends to a “third PhysicalObject, etc. (This usage of indefinite and definite articles is covered by invention Concept Level Rules (Crules), US Patent reference number 317709-US-1, and by the paper Concept-level Rules for Capturing Domain Knowledge, A. Moitra, A. Crapo, R. Palla. 12th IEEE International Conference on Semantic Computing, Jan. 31-Feb. 2, 2018. https://ieeexplore.ieee.org/abstract/document/8334469/ the contents of each of which are hereby incorporated by reference in their entirety for all purposes).

Also significant to note is importance of capturing the constraints on units of inputs and outputs. For example, Equation 7 illustrates the case of a computational model that only works for a single set of units: “ft” as the unit of input and “[degrees] Rankine” as the unit of output. The other equations are modified slightly from those shown in Equations 1, 2, and 4, to take an additional argument showing whether the unit system is Metric or Imperial.

For example, in Equation 5, if the UnitSystem is Metric, the unit of the first argument must be Kelvin, the unit of the 3rd argument must be “g/mole”, the unit of the 4th argument Kelvin, and the unit of the returned value is “m/sec”. Similarly, if the UnitSystem is Imperial, the units are respectively Ranking, “lbm/lbmole”, Rankine, and “ft/sec”. Note that the 2nd argument is unitless. The presence of the unit system argument implies that the encoding of the equation has a computations for both systems of units with appropriate flow control within.

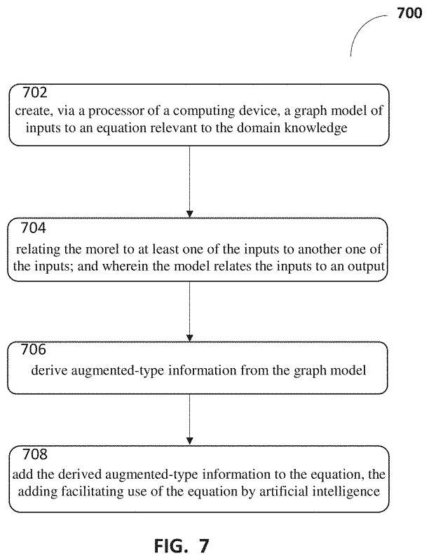

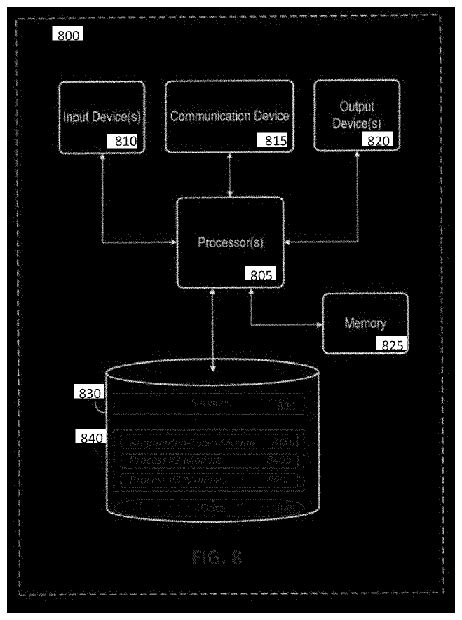

FIG. 7 is a flowchart of an exemplary method 700 of practicing in embodiment of the present invention. In the method 700, a computer system processor models operations related to capturing domain knowledge. The method 700 includes creating, via the processor, a graph model of inputs to an equation relevant to the domain knowledge, in block 702. In block 704, the model relates at least one of the inputs to another one of the inputs, the model relating the inputs to an output. In block 706, augmented-types information is derived from the graph model and added to the equation in block 708, wherein the adding facilitates use of the equation by artificial intelligence.

FIG. 8 is a block diagram illustration of a non-generic computer system 800 on which embodiments of the invention may be implemented. The computer system 800 includes a processor 805 operatively coupled to one or more input devices 810, a communication device 815, one or more output devices 820, a memory 825, and a data storage device 830. The communication device 815 may facilitate communication with external devices, such as a reporting client, or a data storage device.

Input device(s) 810 may comprise, for example, a keyboard, a keypad, a mouse or other pointing device, a microphone, knob or a switch, an infra-red (IR) port, a docking station, and/or a touch screen. Input device(s) 810 may be used, for example, to enter information into the computer system 800. Output device(s) 820 may comprise, for example, a display (e.g., a display screen), a speaker, and/or a printer.

Data storage device 830 may comprise any appropriate persistent storage device, including combinations of magnetic storage devices (e.g., magnetic tape, hard disk drives. and flash memory), optical storage devices, Read Only Memory (ROM) devices, etc., while memory 825 may comprise Random Access Memory (RAM), Storage Class Memory (SCM) or any other fast-access memory.

Services 835 and application 840 may comprise program code executed by processor 805 to cause the computer system 800 to perform any one or more of the processes described herein (e.g., FIGS. 4-7). The embodiments are not limited to execution of these processes by a single computer.

Data 845 (either cached or a full database) may be stored in volatile memory such as memory 825. Data storage device 830 may also store data and other program code and instructions for providing additional functionality and/or which are necessary for operation of apparatus 800, such as device drivers, operating system files, etc.

Services 835 and application 840 including one or more process modules, for example, an augmented types module 840a performs specialized processing to augment integration of models into semantic framework. Process Modules #2 (840a) and #3 (840b) may comprise program code executed by processor 805 to cause the computer system 800 to perform any one or more of the processes described herein (e.g., FIG. 4-7). Embodiments are not limited to execution of these processes by a single apparatus.

This written description uses examples to disclose the invention, including the best mode, and also to enable any person skilled in the art to practice the invention, including making and using any devices or systems and performing any incorporated methods.

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer system including at least one processor for modeling operations related to capturing domain knowledge, the operations comprising:
creating, via the processor, a graph model of inputs to an equation relevant to the domain knowledge;
wherein the graph model relates at least one of the inputs to another one of the inputs; and wherein the model relates the inputs to an output;
deriving augmented-types information from the graph model; and
adding the derived augmented-types information to the equation, the adding facilitating use of the equation by artificial intelligence.

2. The computer system of claim 1, wherein the modeling operations include predicate logic.

3. The computer system of claim 1, wherein the modeling operations include conceptual graphs.

4. The computer system of claim 1, wherein the modeling operations include at least one from the group including ISO standard Common Logic (CL), and Knowledge Interchange Format (KIF).

5. The computer system of claim 1, wherein the graph model is created using web ontology language.

6. The computer system of claim 1, wherein the graph model is formed of at least one from the group including hierarchies, classes, subclasses, and properties.

7. The computer system of claim 1, wherein the augmented-types information includes domain model graph patterns.

8. A tangible computer readable medium having stored thereon computer executable instructions that, if executed by a computer system, cause the computer system to perform a method for modeling operations related to capturing domain knowledge, comprising:
creating, via a processor of the computer system, a graph model of inputs to an equation relevant to the domain knowledge;
wherein the graph model relates at least one of the inputs to another one of the inputs; and wherein the model relates the inputs to an output;
deriving, via the processor, augmented-type information from the graph model; and
adding, via the processor, the derived augmented-type information to the equation, the adding facilitating use of the equation by artificial intelligence.

9. The tangible computer readable medium of claim 8, wherein the modeling operations predicate logic.

10. The tangible computer readable medium of claim 8, wherein the modeling operations include conceptual graphs.

11. The tangible computer readable medium of claim 8, wherein the modeling operations include at least one from the group including ISO standard Common Logic (CL), and Knowledge Interchange Format (KIF).

12. The tangible transitory computer readable medium of claim 8, wherein the graph model is created using web ontology language.

13. The tangible transitory computer readable medium of claim 8, wherein the graph model is formed of at least one from the group including hierarchies, classes, subclasses, and properties.

14. The tangible computer readable medium of claim 8, wherein the augmented-types information includes domain model graph patterns.

15. A method performed on a computer system for performing modeling operations related to capturing domain knowledge, comprising:
creating, via a processor of the computer system, a graph model of inputs to an equation relevant to the domain knowledge;
wherein the graph model relates at least one of the inputs to another one of the inputs; and wherein the graph model relates the inputs to an output;
deriving, via the processor, augmented-type information from the graph model; and
adding, via the processor, the derived augmented-type information to the equation, the adding facilitating use of the equation by artificial intelligence.

16. The method of claim 15, wherein the augmented-types information includes domain model graph patterns.

17. The method of claim 15, wherein the graph model is created using web ontology language.

18. The method of claim 15, wherein the graph model is formed of at least one from the group including hierarchies, classes, subclasses, and properties.

19. The method of claim 15, wherein the graph model is created using web ontology language.

20. The method of claim 15, wherein the modeling operations include at least one from the group including ISO standard Common Logic (CL), and Knowledge Interchange Format (KIF).
